(19) United States
(12) Patent Application Publication
(10) Pub. No.: US 2015/0041447 A1
(43) Pub. Date: Feb. 12, 2015

(54) WELDING DEVICE HAVING A TOUCH SCREEN

(71) Applicant: Fronius International GmbH, Pettenbach (AT)

(72) Inventors: Franz Niedereder, Fischlham (AT); Guenther Neubacher, Neukirchen bei Lambach (AT); Helmut Friedl, Sipbachzell (AT); Rupert Frauenschuh, Sipbachzell (AT)

(73) Assignee: Fronius International GmbH, Pettenbach (AT)

(21) Appl. No.: 14/386,880

(22) PCT Filed: Mar. 11, 2013
(86) PCT No.: PCT/AT2013/050062

§ 371 Date: Sep. 22, 2014

(30) Foreign Application Priority Data
Mar. 23, 2012 (AT) A 50096/2012

(51) Int. Cl. B23K 9/10; G06F 3/041; B23K 9/095

(52) U.S. Cl. CPC B23K 9/1062; B23K 9/0953; G06F 3/041
USPC 219/130.01

(57) ABSTRACT

The invention relates to a welding device (1), comprising a connection (27) for a welding torch (7) for performing a welding process, a power source (2) for supplying the welding torch (7) with a welding current, a control device (4) and an input/output device (18), formed by a touch screen (21) and connected to said control device (4), for setting/displaying parameters, functions and the like. In order to make the welding device (1) as easy to operate as possible and allow parameters to be changed quickly on the touch screen (21), the control device (4) is designed for the sequential and circumferential setting/display of parameters in a main area (28) of the touch screen (21), wherein the settable parameter is displayed emphasised in the centre of the main area (28).

The invention relates to a welding device, comprising a connection for a welding torch for performing a welding process, a power source for supplying the welding torch with a welding current, a control device and an input/output device, connected to said control device and formed by a touch screen, for setting/displaying parameters, functions and the like.

For controlling welding devices and for performing various welding processes, various parameters and functions need to be selected and/or set. They are usually selected and set mainly before starting the welding process, but also during it, by means of various control elements located on the power source of the welding device, on the welding torch, on a remote control or on another component of the welding device. The term “parameter” as used herein includes welding parameters such as the welding current, which have an immediate effect on the welding process, as well as other parameters such as function parameters, which do not directly affect the welding process, but do so indirectly.

More recent generations of welding devices are often equipped with touch screens that allow both input and output/display of the parameters, functions and the like. When using touch screens in welding devices, the individual settable parameters or functions are usually assigned fixed locations that may be selected by the user or the welder. To do so, the user often has to access various user interfaces and/or masks on the touch screen, which makes control considerably more difficult, since the user does not always know which interface and/or mask the relevant parameter or the required function is on.

The object of the present invention is to create a welding device as mentioned above, which makes it possible to set and access parameters, functions and the like before, during or after the welding process as easily, quickly and intuitively as possible. It is advantageous if the settings made by the user and/or the welder may also be made wearing welding gloves. Disadvantages of known welding devices having touch screens are to be eliminated or at least reduced.

The object according to the invention is achieved by a welding device as mentioned above wherein the control device is designed for the sequential and circumferential display of parameters and the setting of parameters in a main area of the touch screen, wherein the settable parameter is displayed emphasised in the centre of the main area. According to this, the parameters are displayed in circumferential fashion in a type of carousel on the touch screen, so the selecting and setting of the parameters by the user is made much easier. By touching the screen, the parameter carousel may be rotated and each parameter that is to be set may be selected quickly and easily. This selected parameter is displayed emphasised in the centre of the touch screen and may be set as desired by directly touching the touch screen or by actuating another control element. This means that the welding device according to the invention allows a diverse setting of various parameters by means of the touch screen before performing the welding process as well as a setting and/or selecting of certain parameters by means of another control element during the performing of the welding process. Instead of or in addition to on the power source of the welding device, the touch screen designed according to the invention may also be arranged on a remote control, a wire feed device etc., which is connected to the power source of the welding device by suitable lines or in a wireless manner. In this case, the parameters are set by means of this touch screen and possibly by a control element on the remote control, the wire feed device etc. In contrast to traditional welding devices, which have touch screens combined with many control elements, the present welding device is laid out more clearly.

Preferably, a combined control element for selecting and modifying the parameters, functions and the like is arranged in the region of the touch screen. Input/output is thus combined by means of a touch screen and a combined control element, which may easily be actuated even when wearing welding gloves. The term “combined control element” includes various control elements which allow combining certain functions. In particular, a combination of a stepless and a stepwise setting of a value of a parameter together with confirming or selecting the parameter should be possible. The parameter selected on the touch screen is displayed emphasised in the centre of the touch screen and may be set as desired either by directly touching the touch screen or by actuating the combined control element. The welding device provided with a combined control element thus allows a diverse setting of various parameters by means of the touch screen before performing the welding process as well as a setting and/or selecting of certain parameters by means of the combined control element during the performing of the welding process. In contrast to welding devices that are equipped with a touch screen only, a welding device having a combined control element allows control via this combined control element when wearing gloves as well. The user does not have to take off the welding gloves before operation. In contrast to traditional welding devices, which have touch screens combined with many control elements, the present welding device is laid out more clearly. The combined control element does not only allow to set certain values for a parameter, a function and the like or to select parameters, functions and the like, but also makes it possible to control the user interface of the touch screen.

Preferably, the control device is designed for displaying at least one preceding and at least one succeeding parameter of the sequence of parameters next to the centrally displayed, settable parameter in the main area of the touch screen. This means that the parameters are displayed in a type of carousel on the touch screen, thereby making it easier for the user to select and set the parameters. By actuating the possible combined control element and/or by touching the touch screen, the parameter carousel may be rotated and the parameter to be set may be selected quickly and easily. This selected parameter is displayed in the centre of the touch screen in selection mode, which is an advantageous way for the user to see the parameter currently to be set, which is always arranged in the centre of the main area of the touch screen, as well as to perceive at least two neighbouring parameters that may be selected next. The user may thus perform the selection of the next parameter to be set quickly and easily by moving the parameter carousel to the left or to the right.

Preferably, the settable parameter is displayed larger than the at least one preceding and the at least one succeeding parameter of the sequence on the touch screen. In this way, the parameter that may be set is emphasised appropriately on the touch screen. Furthermore, the selected parameter may also be emphasised by various graphical effects such as a border or a coloured representation. Once a parameter has been selected from the carousel by touching the touch screen or by actuating the possibly present combined control element, its value may be modified. Preferably, a scale of the possible range of settings for the parameter as well as the currently set value are displayed, depending on the preferences.

According to another feature of the invention, a control area for changing the sequence of parameters on the touch screen is provided on the touch screen. To be able to adapt the welding device to the individual needs of the user, the parameters displayed and arranged in the carousel and their order may be set.

A control area for displaying a selected parameter as a progression of a curve according to time may also be provided on the touch screen. By actuating this control area on the touch screen, a display mode (welding curve view) is selected, and the selected parameter is displayed as a curve as a function of time. Such curve representations are also used for complex processes, for example welding start procedures. This is a great advantage for various welding processes/detailed processes. The welding current, for example, may be displayed graphically, according to time, on the touch screen or in an area of the touch screen in order to provide the user an overview over the temporal progress of the welding current during the welding process.

Preferably, a status line for displaying the status of the set welding process is provided in the upper region of the touch screen, and at least one menu bar, preferably arranged on the side, is provided to display control areas for selecting parameters or making settings. In the status line, information on important settings, activated functionalities, the logged-on user, time, date and present errors and the like is provided to the user in the form of text or symbols/icons.

A control area for switching to full screen mode, in which the at least one menu bar (which is preferably arranged on the left-hand and/or on the right-hand side) is hidden and the main area of the touch screen is displayed larger, may be provided on the touch screen. By this switching to full screen mode, the touch screen is restricted to the essential views and less essential setting options or information are/is hidden. Full screen mode may be considered as a simplified and/or reduced representation of the control interface.

In order to protect the touch screen from weld spatters or the like, a preferably transparent protective cover may be provided. The possible combined control element is arranged outside this protective cover, so the control element may be actuated even when the protective cover is used to cover the touch screen. This makes it possible to actuate the combined control element near the touch screen even during the welding process when the touch screen is covered.

The control element is preferably formed by a push/rotary controller. Such a push/rotary controller provides a simple implementation of a combined control element. By pushing the push/rotary controller, the selection and/or the value of a parameter may be confirmed, and by turning the push/rotary controller, a stepless setting of the value of the parameter or the selection of a different parameter and/or a different view on the touch screen is done. Provided that the control element is of sufficient size, it may be actuated particularly conveniently even when wearing welding gloves.

By providing an interface connected to the control device on the welding device, various data or programmes may be exported from the welding device or imported into the welding device. The interface is preferably arranged in the region of the input and/or output device. In addition, new display interfaces and/or layouts for the touch screen may be installed or the user interfaces or the like that have been adapted directly on the welding device by the user may be read out via the interface. For example, a USB (Universal Serial Bus) interface allows storing individual settings of a welding process in an external memory, in particular on a USB flash drive, and providing them for use by another welding device. By means of a WLAN (Wireless Local Area Network) adapter connected to a USB port, a connection to local networks or the Internet may be established as well. Other interfaces such as Ethernet interfaces may also be provided for connecting the welding device to local networks or the Internet. Furthermore, such interfaces may allow remote maintenance of the welding device and software updates.

At least one function key may be arranged in the region of the touch screen. For example, a key for initiating a process for inserting a welding wire or a key for initiating a process for checking the required amount of a shielding gas may be provided as such a function key. External function keys of this type are primarily used for frequently used functions so certain control procedures, determination of actual values etc. may be performed quickly and easily by a single push of a function key. In this way, the relevant function such as the insertion process of the welding wire may be performed by pushing the function key once. Provided that the key is of sufficient size, it may be actuated conveniently when wearing welding gloves.

If the control device is designed for displaying a scale of the range within which the parameter may be set, the range within which a setting of the parameter may be made by means of the control element may be displayed for the user in a particularly clearly laid out manner. Here, it is advantageous for the setting ranges for various welding processes and/or parameters to be changeable and for the setting ranges to be adaptable in a flexible way. As a consequence, the ideal ranges are available for the user at all times. The scale may be displayed in the form of a circle or a circle sector or in the form of bars, for example.

Preferably, the scale conforms to the set parameters of the welding process and/or to the components of the welding device in use, in particular the power source. This means that, depending on the further set parameters of the welding process, the scale and/or the range within which the setting of the currently selected parameter can be made is displayed automatically. If the parameter of the conveying speed of the welding wire is selected, for example, the range of the reasonably possible wire conveying speeds for the selected welding process is displayed automatically. The user may select the desired value from this range that is displayed on the scale by actuating the control element or touching the touch screen appropriately. The automatic association of the scale is done by corresponding stored functions or tables. These functions or tables contain the ranges within which the value of a parameter may be varied for each settable parameter, depending on the selected further parameters of the welding process.

If a memory for storing the set parameters of a welding job together with a unique identification for the welding job is provided, the user may keep his individual settings of a certain welding job for documentation or later use.

As has already been mentioned above, the touch screen may be arranged on the power source and/or on a component of the welding device, in particular a wire feed device, a remote control etc.

The present invention is discussed in more detail by means of the attached drawings, which show exemplary embodiments of a welding device and a touch screen of a welding device. In the drawings:

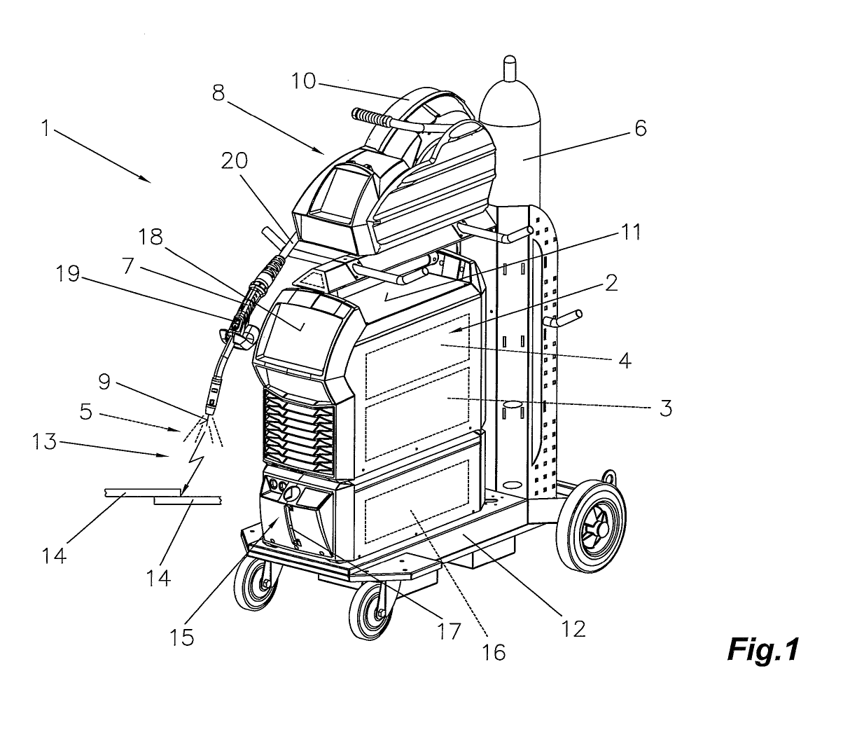

FIG. 1 shows a schematic illustration of a welding device;

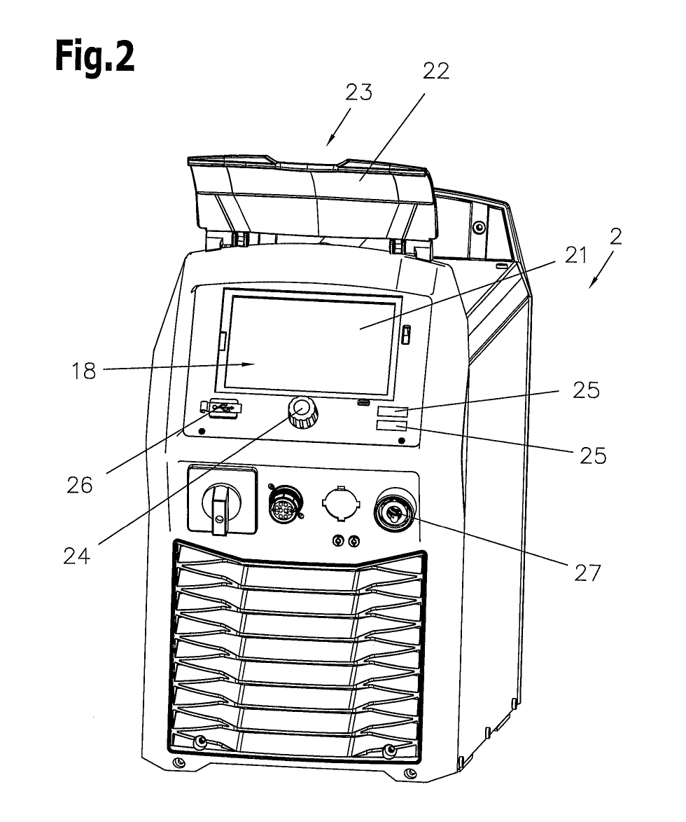

FIG. 2 shows the view of a power source of a welding device having a touch screen;

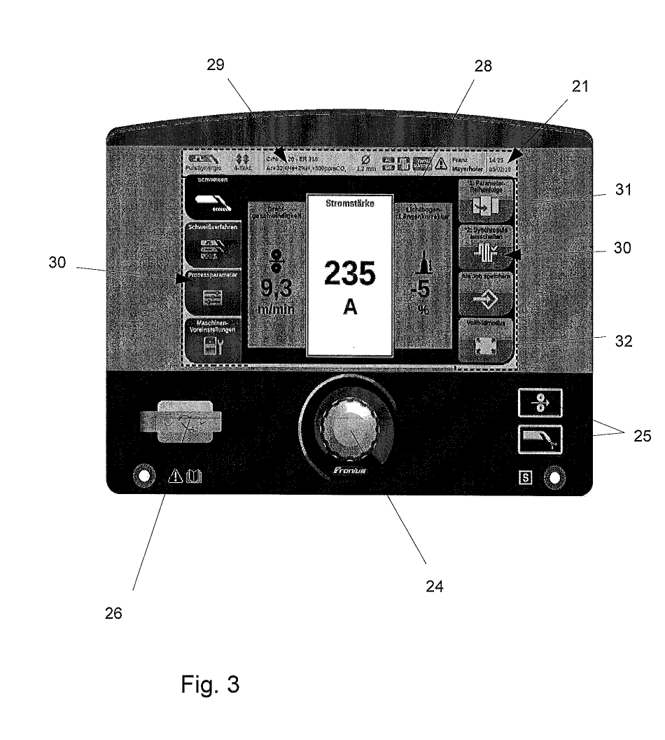

FIG. 3 shows a view of a control unit of a power source of a welding device having a touch screen;

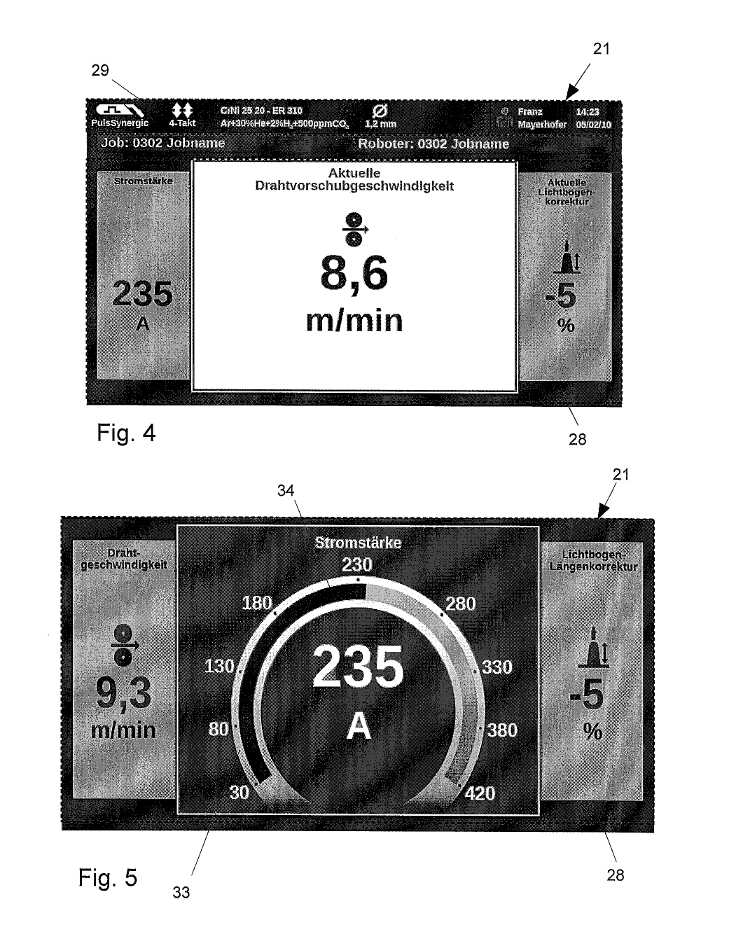

FIG. 4 shows a view of the touch screen in full screen mode in selection mode;

FIG. 5 shows a view of the touch screen in full screen mode in setting mode;

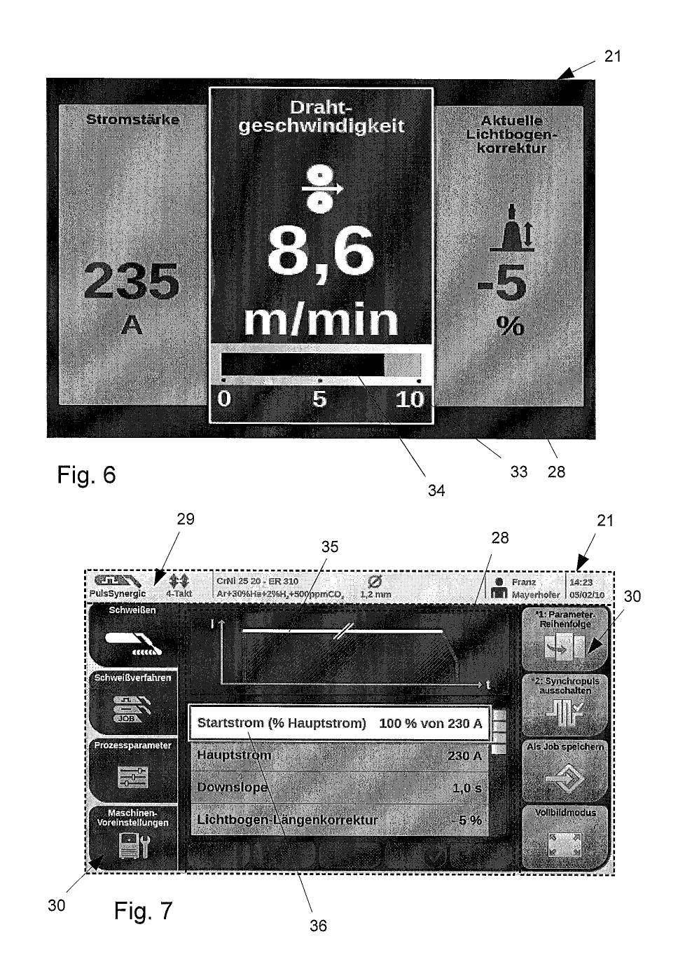

FIG. 6 shows another view of the touch screen in full screen mode in setting mode; and

FIG. 7 shows a view of the touch screen in curve view mode.

FIG. 1 shows a schematic illustration of a welding device 1 for many different processes and/or methods such as MIG/MAG welding and/or TIG welding or electrode welding methods, doublewire/tandem welding methods, plasma methods or brazing and soldering methods etc. The welding device 1 comprises a power source 2 with a power unit 3 arranged therein, a control device 4 and further components and lines (not shown) such as a switching member, control valves etc. The power source 2 and its components are arranged in a corresponding housing 11. The control device 4 may be connected to a control valve that is arranged in a supply line for a shielding gas such as CO₂, helium or argon and the like between a gas storage 6 and a welding torch 7. Moreover, the control device 4 may be used to control a wire feed device 8, as it is common for MIG/MAG welding, with an additional material and/or a welding wire 9 being supplied to the region of the welding torch 7 via a supply line from a supply coil 10 and/or a wire coil or an external drum coil (wire drum). Of course it is possible for the wire feed device 8 to be integrated into the welding device 1, in particular into the housing 11 of the power source 2, instead of being an additional device placed on a cart 12, as illustrated in FIG. 1. It is also possible for the wire feed device 8 to be placed directly on top of the welding device 1, with the housing 11 of the power source 2 being formed for receiving the wire feed device 8 on the top surface. In this case, the cart 12 can be omitted. The wire feed device 8 may also supply the welding wire 9 to the process site outside of the welding torch 7, in which case a non-melting electrode is preferably arranged within the welding torch 7, as is common in TIG welding.

The current for creating an electric arc 13 between the electrode or the welding wire 9 and a workpiece 14 is supplied to the welding torch 7, in particular the electrode or the welding wire 9, by the power element 3 of the power source 2 via a welding line (not shown). The workpiece 14 to be welded is connected to the power source 2 via a further welding line for the further potential, in particular the earth cable, so that an electric circuit can be created by means of the electric arc 13.

For cooling the welding torch 7, it may be connected to a liquid tank, in particular a water tank 16 having a level indicator 17, via a cooling device 15 and possible intermediate components such as a flow controller. The individual components of the welding system, i. e. the power source 2, the wire feed device 8 and the cooling device 15, are formed in such a way that they can be stacked or placed on top of each other safely.

The welding device 1, the power source 2 in particular, further comprises an input/output device 18 for setting and/or retrieving and displaying all the various parameters, operation modes or welding programmes. The parameters, operation modes or welding programmes that are set by the input/output device 18 are communicated to the control device 4, which then actuates the individual components of the welding device 1 and/or defines appropriate set points for regulating or controlling. It is also possible to perform setting procedures via the welding torch 7 by using an appropriate welding torch 7 having a welding torch input/output device 19. In this case, the welding torch 7 is preferably connected to the welding device 1, in particular the power source 2 or the wire feed device 8, by data and supply lines. For starting the welding process, the welding torch 7 usually comprises a starting switch (not shown), so the electric arc 13 can be ignited by actuating the starting switch.

Furthermore, in the exemplary embodiment shown, the welding torch 7 is connected to the welding device 1 via a hose package 20. In the hose package 20, the individual lines such as the supply line and/or lines for the welding wire 9, for the gas 5, for the cooling circuit, for data transmission etc. are arranged from the welding device 1 to the welding torch 7 while the earth cable is preferably connected separately to the power source 2.

In general, not all components mentioned above have to be used and/or incorporated for the various welding methods and/or welding devices 1 such as MIG/MAG devices or plasma devices. It may be possible for the welding torch 7 to be formed as an air-cooled welding torch 7 so the cooling device 15 can be omitted, for example. The welding device 1 is thus formed by at least the power source 2, the wire feed device 8 and the cooling device 15, which components may all be arranged within a common housing 11.

FIG. 2 shows a view of a power source 2 of a welding device 1 having an input/output device 18 formed by a touch screen 21 for setting parameters of the welding process. Preferably, the touch screen 21 is designed using resistive touch technology in order to allow actuation not only by the fingers of the user but by a stylus pen or the like as well. The size of the touch screen 21 depends on the size of the power source 2 or other component of the welding device 1 and the diversity of the parameters, functions and the like and the control options to be displayed. When performing a welding process, the sensitive touch screen 21 may be protected by a preferably transparent protective cover 22, which is pivotably connected to the welding device 1. In the illustrated exemplary embodiment, the protective cover 22 may be hinged down over the touch screen 21. Other mechanisms such as protective covers 22 to be slid over the touch screen 21 (not illustrated), for example, are possible as well. The protective cover 22 has a cut-out 23 for keeping clear a possible combined control element 24 located near the touch screen 21 when the protective cover 22 is shut, so the combined control element 24 may be actuated even when the touch screen 21 is covered. Preferably, the control element 24 is arranged on the side of or below the touch screen 21. Of course the control element 24 allows making the same changes and settings as directly on the touch screen 21 itself. As a consequence, the user may modify certain settings of parameters via the combined control element 24 when performing a welding process even when wearing welding gloves. Preferably, the combined control element 24 is formed by a push/rotary controller, which can perform at least two functions. In addition to the combined control element 24, function keys 25 for initiating various frequently used functions such as inserting the welding wire 9 or performing a shielding gas checking procedure may be provided. Furthermore, an interface 26, for example a USB interface, may be arranged on the power source 2 in order to allow a connection of the welding device 1 to external devices for exchanging data and/or information. Moreover, interfaces for connecting the welding device 1 and/or the power source 2 to a local network or the Internet may be provided, in particular Ethernet interfaces (not illustrated), preferably arranged on the back of the welding device 1. An earth cable (not illustrated) is connected to the power source 2 via a connection 27.

In FIG. 3, an enlarged view of a control unit of a power source 2 of a welding device 1 having a touch screen 21 is shown. The touch screen 21 forming the input/output device 18 includes a main area 28, in which the parameters to be set may be displayed and set and/or modified. According to the invention, the parameters are displayed in a sequential and circumferential representation in the main area 28 of the touch screen 21. The currently selected and settable parameter is displayed emphasised in the centre of the main area 28. At least one preceding and one succeeding parameter of the sequence are displayed to the left and to the right of the selected and settable parameter, respectively. This means that, in the illustrated example, three parameters are displayed in the main area 28 of the touch screen 21 at the same time, but only the parameter displayed emphasised in the centre may be modified and/or set at any given time. The selected and settable parameter, the amperage in the illustrated example, is emphasised with respect to the other parameters on display by displaying it larger and possibly in colour or surrounded by a border. The user can move the individual parameters, so very different parameters may be moved to the centre of the main area 28 as required. Moving the parameters is done in the form of a parameter carousel, wherein the parameter displayed next to the central parameter, depending on the direction of rotation, is moved to the centre, and then a different parameter or the parameter that was displayed from the opposite side before is displayed next to the central parameter. This means that an uneven number of parameters is displayed in the main area 28 of the touch screen 21, with the parameter located in the centre being emphasised. For example three, five, seven etc. parameters are displayed in the main area 28. This type of display enables the user to move the parameters in the form of a carousel in both directions, i. e. to the left or to the right, and to quickly arrange the desired parameter in the centre of the touch screen 21.

A status line 29 displaying information on important settings, activated functionalities, the logged-on user, time, date and present errors in the form of text or icons is preferably located above the main area 28 of the touch screen 21. Menu bars 30 containing control areas for navigation or for setting frequently used functions are located on both sides of the main area 28 of the touch screen 21. In the right-hand menu bar 30, a control area 31 for selecting and/or changing the parameters displayed in the carousel and their order is displayed. The user can thus set the power source 2 according to his individual needs and select the parameters he wants to set, modify or monitor during the welding process. The user can set the parameters to be displayed in the parameter carousel and their order individually, thereby obtaining an ideal customisation and having the most important parameters for the welding process available at all times. A further control area 32 (the lowest control area in the right-hand menu bar 30 herein) allows switching to full screen mode, which is discussed in more detail with reference to FIG. 4. Preferably, the respective control areas 31, 32 in the menu bars 30 include self-explanatory pictographs and/or short explanatory texts, so the user can operate the power source 2 without extensively studying an operation manual. Depending on the function, the text or the pictograph/symbol may be omitted.

Possible control areas in the menu bars 30 and their functions will be described briefly below. The uppermost control area in the left-hand menu bar 30 represents the menu item “Welding”, which is selected when a welding process is carried out. The next control area in the left-hand menu bar 30 including the symbols for welding torches and the text element “JOB” is used for selecting various welding methods such as standard welding method, pulse welding method, CMT (cold metal transfer) welding method etc. The control area located below in the left-hand menu bar 30 including the symbol of three sliders is used for setting the parameters of the process. By pressing this control area, various process parameters may be set. The lowest control area in the left-hand menu bar 30 including the symbol of a welding device and a wrench is used for defining and modifying preferences of the welding device. By selecting this control area on the touch screen 21, various basic settings such as the type or colour of displays may be defined.

In the right-hand menu bar 30 of the touch screen 21 the uppermost control area 31 including the symbol of the parameter carousel (three rectangles and a curved arrow) is reserved for modifying the parameters of the parameter carousel. By selecting this control area 31, a corresponding sub-menu appears on the touch screen 21 for defining the parameters to be arranged in the carousel and their order. The control area arranged below and including the symbol of a rectangular function and a check mark is used for switching on and off certain special functions such as a sync pulse. The third control area in the right-hand menu bar 30 including the pictograph of a tilted square and an arrow allows saving various settings as a welding job so these settings are available for later applications. Eventually, the lowest control area 32 in the right-hand menu bar 30 including the symbol of a rectangle and arrows pointing outward at the corners is intended for switching to full screen mode as described above, in which the menu bars 30 are hidden and the main area 28 of the touch screen 21 is displayed larger (see FIG. 4).

Of course, new control areas including new sub-functions may appear when selecting a control area in the menu bars 30, making the operation of the welding device 1 and modifications of the parameters, functions and the like easier.

FIG. 4 shows a view of the touch screen 21 according to FIG. 3 in full screen mode, which is entered after actuating a respective control area 32 on the touch screen 21. In full screen mode, the menu bars 30 displayed on the sides of the main area 28 in FIG. 3 are hidden and the main area 28 of the touch screen 21 is displayed correspondingly larger. The status line 29 preferably remains on display since it indicates important information for the user. Full screen mode is a simplified and/or reduced mode wherein only the essential parts or parameters of the welding process are displayed on the touch screen 21. Returning to normal mode, in which the menu bars 30 on the sides of the main area 28 of the touch screen 21 are displayed again and their functions may be actuated, is done by touching the touch screen 21, for example. In this selection mode the parameters may be selected.

FIG. 5 displays the touch screen 21 in setting mode, wherein the size of the display area corresponds to full screen mode. For the sake of simplicity, the status line 29, which is usually arranged above the main area 28 of the touch screen 21, is not illustrated here. Setting mode is entered by actuating the combined control element 24, in particular by pushing the push/rotary controller. Here, a scale 33 including the settable range of the selected parameter is displayed. In the illustrated exemplary embodiment the selected parameter is the welding current I, which may be set between 30 and 420 A. The setting bar 34 indicates the currently set value for the welding current I. In addition to the setting bar 34, the value of the parameter may also be displayed as a number (235 A here). By dragging the setting bar 34 on the touch screen 21 or by turning the combined control element 24, the value of the parameter (the welding current I here) may be set to the desired value. Touching the touch screen 21 or pushing the combined control element 24 returns to full screen mode according to FIG. 4.

Due to different additional parameters and/or functions, the settable range of the parameter, between 30 and 420 A in the case shown, is designed variably. If the setting remains the same but the selection of material is changed, for example, the settable range of a parameter may be changed from 30-420 A to 20-350 A. Here, certain parameters are taken into account for defining the respective settable range. The installed components such as the power element used, the wire feed device etc. may also contribute to the definition of the settable range. When using a power element for 300 A, for example, displaying a range of up to 420 A is not reasonable since this value of the current cannot be set. When replacing the components of the welding device, the scales for the parameters, in particular the setting ranges, are defined based on the characteristic numbers stored for these components.

FIG. 6 shows another view of the touch screen 21 in setting mode, with the parameter of the conveying speed of the welding wire being displayed. The status line 29 above the main area 28 of the touch screen 21 is not illustrated here as well. The value range within which the conveying speed of the welding wire may be set is between 0 and 10 m/min in the example shown. Again, the setting bar 34 indicates the currently set value (8.6 m/min here) for the parameter. In addition to this, the set value is also displayed as a number on the touch screen 21.

Finally, FIG. 7 shows the touch screen 21 of the welding device 1 in curve view mode. Here, the currently selected parameter may be displayed graphically in the form of a time diagram 35 by selecting an appropriate control area in a menu bar 30 on the touch screen 21. In the example shown, the parameter of the welding current I is displayed in a part of the main area 28 of the touch screen 21 as a function of time t. Below the time diagram 35 a parameter list 36 is present as well, wherein the displayed and selected parameter (the welding current here) is emphasised appropriately, for example surrounded by a border. The temporal progress of the parameter (the welding current I here) allows to communicate relevant information on changes during the welding process to the user in a clearly laid out manner.

It is essential here that when a parameter is modified, the user can read the effects from the characteristic curve immediately because it changes according to the setting made.

Via the touch screen 21 and the combined control element 24, the present welding device 1 provides a particularly flexible and conveniently operable setting option for the user and/or the welder, which may be adapted to the respective needs in a particularly easy manner.

1-16. (canceled)

17. A welding device (1), comprising a connection (27) for a welding torch (7) for performing a welding process, a power source (2) for supplying the welding torch (7) with a welding current, a control device (4) and an input/output device (18), connected to said control device (4) and formed by a touch screen (21), for setting/displaying parameters, functions and the like, wherein the control device (4) is designed for the sequential and circumferential setting/display of parameters in a main area (28) of the touch screen (21) in the form of a parameter carousel, wherein the settable parameter is displayed emphasized in the center of the main area (28), wherein the control device (4) is designed for displaying at least one preceding and at least one succeeding parameter of the sequence of parameters next to the centrally displayed, settable parameter in the main area (28) of the touch screen (21), and wherein a combined control element (24) for selecting and modifying the parameters, functions and the like is arranged in the region of the touch screen (21).

18. The welding device (1) according to claim 17, wherein the settable parameter is displayed larger than the at least one preceding and the at least one succeeding parameter of the sequence on the touch screen (21).

19. The welding device(1) according to claim 17, wherein a control area (31) for changing the sequence of parameters on the touch screen (21) is provided on the touch screen (21).

20. The welding device (1) according to claim 17, wherein a control area for displaying a selected parameter as a course of curve as a function of time is provided on the touch screen (21).

21. The welding device (1) according to claim 17, wherein on the touch screen (21) a status line (29) for displaying the status of the welding process is provided, preferably arranged in the upper region of the touch screen (21), and at least one menu bar (30) is provided, preferably arranged on the side of the touch screen (21), to display control areas for selecting parameters or making settings.

22. The welding device (1) according to claim 21, wherein a control area (32) for switching to full screen mode, in which the at least one menu bar (30) is hidden and the main area (28) of the touch screen (21) is displayed larger, is provided on the touch screen (21).

23. The welding device (1) according to claim 17, wherein a transparent protective cover (22) for the touch screen (21) is provided, wherein the combined control element (24) is arranged outside the protective cover (22), so the control element (24) may be actuated even when the touch screen (21) is covered.

24. The welding device (1) according to claim 17, wherein the control element (24) is formed by a push/rotary controller.

25. The welding device (1) according to claim 17, wherein an interface (26) connected to the control device (4), preferably a USB interface, is provided and wherein the interface (26) is preferably arranged in the region of the input and/or output device (18).

26. The welding device (1) according to claim 17, wherein at least one function key (25) is provided in the region of the touch screen (21), in particular a key for initiating a process for inserting a welding wire (9) and a key for initiating a process for checking the required amount of a shielding gas (5).

27. The welding device (1) according to claim 17, wherein the control device (4) is designed for displaying a scale (33) of the range within which the parameter may be set.

28. The welding device (1) according to claim 27, wherein the scale (33) conforms to the set parameters of the welding process and/or to components of the welding device (1) in use, in particular the power source (2).

29. The welding device (1) according to claim 17, wherein a memory for storing the set parameters of a welding job together with a unique identification for the welding job is provided.

30. The welding device (1) according to claim 17, wherein the touch screen (21) is arranged on the power source (2) and/or on a component of the welding device (1), in particular a wire feed device (8), a remote control etc.
